(19) United States
(12) Patent Application Publication
(10) Pub. No.: US 2008/0244350 A1
(43) Pub. Date: Oct. 2, 2008

(54) APPARATUS AND METHOD FOR AUTOMATIC REPEAT REQUEST IN MULTIPLE INPUT MULTIPLE OUTPUT SYSTEM

(75) Inventors: Elisabeth de Carvalho, Aaiborg (DK); Petar Popovski, Aaiborg (DE); Jieping Hu, Aaiborg (DK); David Mazzarese, Suwon-si (KR); Hak-Ju Lee, Bupyeong-gu (KR); Young-Kwon Cho, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/053,201

(22) Filed: Mar. 21, 2008

(30) Foreign Application Priority Data
Mar. 21, 2007 (KR) 2007-0027603

(51) Int. Cl. H04L 1/08; G06F 11/14

(52) U.S. Cl. 714/748; 714/E11.113

(57) ABSTRACT

A method for an Automatic Repeat reQuest (ARQ) at a receiver in a Multiple Input Multiple Output (MIMO) system wherein when a received packet is erroneous and the erroneous packet is received from the weakest antenna in a Space Multiplexing (SM) mode, a first smallest number of retransmissions is computed to acquire a Signal to Noise Ratio (SNR) within or above an Adaptive Modulation and Coding (AMC) level. When the first number of the retransmissions is greater than a threshold, the sender is requested to retransmit the packets from the strongest antenna in the SM mode and when the first number of the retransmissions is smaller than the threshold, the sender is requested to retransmit the packets from the weakest antenna in the SM mode.

### PRIORITY

This application claims priority under 35 U.S.C. § 119(a) to a Korean patent application filed in the Korean Intellectual Property Office on Mar. 21, 2007 and assigned Serial No. 2007-27603, the entire disclosure of which is hereby incorporated by reference.

### BACKGROUND OF THE INVENTION

1. Field of the Invention

The present invention relates generally to an Automatic Repeat reQuest (ARQ). More particularly, the present invention relates to an apparatus and a method for enhancing a transmission efficiency by changing a transmission mode by accounting for a delay that occurs when a Base Station (BS) receives Channel State Information (CSI) from a Mobile Station (MS) and reflects the CSI on a next data transmission in a broadband wireless access communication system using a Multiple Input Multiple Output (MIMO) scheme based on an Institute of Electrical and Electronics Engineers (IEEE) 802.16 protocol.

2. Description of the Related Art

In a broadband wireless access communication system, a Base Station (BS) sends a pilot in every DownLink (DL) frame, and a Mobile Station (MS) estimates a channel using the pilot and feeds Channel State Information (CSI) back to the BS.

The CSI is used to decode the data received from the BS, to schedule data for another MS, and to determine a modulation level of data to be sent to the other MS.

The MS measures a channel condition and transmits the measured CSI to the BS until the BS receives the CSI and determines the modulation level. However, during this procedure a delay occurs. If the delay is longer than a coherence time, the modulation level may be set inadequately.

To address this situation, the BS can add a margin to an Adaptive Modulation and Coding (AMC) threshold computed according to an average Signal to Noise Ratio (SNR) and a parameter describing a channel variation. The AMC level selected in the retransmission is adapted to the CSI and the variation of the CSI measured at the MS. An AMC mode is defined as a specific combination of the modulation and the coding.

Additionally, it is important to reduce the feedback of the CSI. For doing so, a well-adapted ARQ process can compensate for the reduced feedback.

Because of the delay during the scheduling, the MS may not be scheduled on every frame when a channel of the MS is temporarily bad or there is no data to be sent to the BS. In this case, the CSI at the BS, with respect to the MS, may not be up to date.

If the BS utilizes the delayed CSI, a decoding error may occur at the MS. Obviously, the MS can acquire its CSI more accurately than the BS because the MS estimates the channel in every frame and the parameters according to the channel variation. The CSI may vary due to a changing interference.

In order to handle the channel variation, the application of the same AMC level to both antennas has been considered. However, no consideration was given to an Automatic Repeat reQuest (ARQ) scheme in a Multiple Input Multiple Output (MIMO) system, which selects the best antenna based on the CSI and retransmits data.

Therefore, an apparatus and a method are required for enhancing the throughput using the ARQ in the MIMO system, which selects the best antenna based on the CSI and retransmits data.

### SUMMARY OF THE INVENTION

The present invention has been designed to address at least the above-mentioned problems and/or disadvantages and to provide at least the advantages described below. Accordingly, an aspect of the present invention is to provide an apparatus and a method for performing an ARQ in a MIMO system.

Another aspect of the present invention is to provide an apparatus and a method for performing an ARQ to efficiently retransmit data by selecting the best antenna based on CSI or by using a Space Multiplexing (SM) scheme and adjusting a modulation level in a MIMO broadband wireless access communication system.

The above and other aspects are achieved by providing a method for an ARQ at a receiver in a MIMO system. The method includes receiving packets from a sender, and when one of the packets is erroneous and the erroneous packet is received from the weakest antenna in a Space Multiplexing (SM) mode, computing a first smallest number of retransmissions to acquire a Signal to Noise Ratio (SNR) within or above an Adaptive Modulation and Coding (AMC) level. When the first number of the retransmissions is greater than a threshold, the sender is requested to retransmit the packets from the strongest antenna in the SM mode. When the first number of the retransmissions is smaller than the threshold, the sender is requested to retransmit the packets from the weakest antenna in the SM mode.

Other aspects, advantages, and salient features of the present invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments the present invention will become more apparent from the following detailed description taken in conjunction with the accompanying drawings, in which:

FIG. 1 is a flowchart illustrating a retransmission method of an MS according to an embodiment of the present invention;

FIGS. 2A and 2B are flowcharts illustrating a retransmission method of an MS according to an embodiment of the present invention;

FIGS. 3A and 3B are flowcharts of a retransmission method of an MS according to an embodiment illustrating the present invention; and

FIG. 4 is a block diagram illustrating a terminal and a network device according to an embodiment of the present invention.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. While it includes various specific details to assist in that understanding, these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention provides an apparatus and a method for an Automatic Repeat reQuest (ARQ) in a Multiple Input Multiple Output (MIMO) system. Hereinafter, the following description will be directed to a 2×2 MIMO system using a Space Multiplexing (SM).

Basically, Adaptive Modulation and Coding (AMC) thresholds are determined by a Base Station (BS) and forwarded to a Mobile Station (MS). AMC levels are computed according to Channel State Information (CSI) available at the BS. However, all other decisions are made at the MS. That is, a Signal to Noise Ratio (SNR) is measured based on a pilot signal received at the MS, and an appropriate request from the MS is transmitted to the BS.

The ARQ scheme of the present invention pertains to a retransmission of the same data at a symbol level. More specifically, the present invention provides mechanisms in the following cases described according to increased complexity and feedback information required.

The BS operates in an SM mode. Thereafter, the MS feeds back an Acknowledgment (ACK) and a Negative ACK (NACK) as to an antenna over which an erroneous packet to be retransmitted is transmitted. The MS sends 1-bit information with respect to each packet decoded correctly and the first packet transmitted from the antenna i. The t-bit information signifies whether the AMC level of a newly transmitted packet from the antenna i should be increased or decreased by one level.

The BS can be requested to switch to an Antenna Selection (AS) mode. In addition to the information fed back by the MS, the MS feeds back information indicating if the system should enter the system SM mode to the AS mode.

As indicated above, the present ARQ scheme takes accounts for channel variation. Accordingly, the MS computes and converts uncertainty of the measured SNR to a margin. Based on the compensated SNR with the margin, the MS computes a throughput of different retransmission possibilities and selects the best antenna.

For understanding of the present invention, a 2×2 MIMO system is employed and the following notations are defined where _ indicates a row vector.

Xᵢ(t) is a packet transmitted from the transmit antenna i at a time t, with a variance σ_{X}².

hⱼᵢ(t) is a channel coefficient from the transmit antenna i to a receive antenna j at the time t.

$$H ( t ) = [ \begin{matrix}{h}_{11} ( t ) & {h}_{12} ( t ) \\ {h}_{21} ( t ) & {h}_{22} ( t )\end{matrix} ]$$

is a 2×2 MIMO channel at the time t, which is expressed as:

$$H ( t ) = [ \begin{matrix}{H}_{1} ( t ) & {H}_{2} ( t )\end{matrix} ]$$

$$where$$

$${H}_{1} ( t ) = [ \begin{matrix}{h}_{11} ( t ) \\ {h}_{21} ( t )\end{matrix} ] and$$

$${H}_{2} ( t ) = [ \begin{matrix}{h}_{12} ( t ) \\ {h}_{22} ( t )\end{matrix} ] .$$

Nⱼ(t) is an additive noise at the receive antenna j at the time t with a variance σ_{N}². σ_{N}² is constant at every antenna.

$${γ}_{ji} ( t ) = \frac{{‖ {h}_{ji} ( t ) ‖}^{2}}{{σ}_{N}^{2}} and {γ}_{i} ( t ) = \frac{‖ {H}_{i} ( t ) ‖}{{σ}_{N}^{2}}$$

are SNRs for hⱼᵢ(t) and Hᵢ(t). Yⱼ(t) is a receive signal at the receive antenna j at the time t.

\hat{X}ᵢ(t) is a decoded signal of Xᵢ(t) at the time t.

An input/output relationship of the 2×2 MIMO system is as follows:

Y(t)=HX(t)+N(t)

L_{MAX} denotes a maximum number of retransmissions. Lₘₐₓ(i) is a maximum number of remaining retransmissions for the packet received from the antenna i.

An ARQ channel is an equivalent channel resulting from the packet combining.

For example, if data sent at the time t is

$$\underline{X} ( t ) = [ \begin{matrix}\underline{{X}_{1}} ( t ) \\ {\underline{X}}_{2} ( t )\end{matrix} ] ,$$

$$Y ( t ) = H ( t ) X ( t ) + N ( t ) , \\ where H ( t ) = [ \begin{matrix}{H}_{1} ( t ) & {H}_{2} ( t )\end{matrix} ] , \\ {H}_{i} ( t ) = [ \begin{matrix}{H}_{[ {\underline{X}}_{i} ( t ) ]} ( t - L ) \\ ⋮ \\ {H}_{[ {\underline{X}}_{i} ( t ) ]} ( t - 1 ) \\ {H}_{[ {\underline{X}}_{i} ( t ) ]} ( t )\end{matrix} ] .$$

H_{[X}_{ᵢ}_{(t)]}(t−k) is a channel from the antenna that transmits the packet Xᵢ(t) at the time t. N(t) is a vector which groups noise samples at the receiver from a time t−L to the time t.

Hereafter, a method for selecting the AMC level by the BS for the newly transmitted packet is described. The AMC thresholds are computed at the BS and forwarded to the MS. An interval of a given AMC level is defined as an interval of SNR values for which the AMC level is selected.

For the first modulation level allowed, a lower bound of the AMC interval is defined as a superior bound minus 3˜5 dB depending on the AMC design.

For the selection of the AMC level for the newly transmitted packet, the following three cases can be considered.

First, the SM is used to select the AMC level for a new packet transmitted from each antenna. The AMC level for each stream is selected based on the SNRs obtained at the outputs of a Zero-Forcing (ZF) equalizer, which is computed for the channel matrix H(t).

Second, the SM is used, a new packet is transmitted from an antenna 1, and an antenna 2 is used to retransmit a packet. It is assumed that the packet from the antenna 2 has already been transmitted Lₜ<L times. Next, the AMC level for the newly transmitted packet is selected based on the output of the ZF equalizer. The channel matrix is H (t)=[H₁(t) H₂(t)], with

$${H}_{1} ( t ) = [ \begin{matrix}0 \\ ⋮ \\ 0 \\ {H}_{1} ( t )\end{matrix} ] ; {H}_{2} ( t ) = [ \begin{matrix}{H}_{[ {\underline{X}}_{2} ( t ) ]} ( t - {L}_{1} ) \\ ⋮ \\ {H}_{[ {\underline{X}}_{2} ( t ) ]} ( t - 1 ) \\ {H}_{2} ( t )\end{matrix} ] .$$

Third, the AS is used. The AMC level of the signal stream is determined according to a single value of the post-processing SNR obtained at the MS.

In this embodiment of the present invention, packets are considered to have the same duration, which signifies that they contain the same number of symbols. Packets sent from both antennas to the MS begin and end at the same time. Accordingly, there is no interference from other MSs in the SM mode.

The MS computes the SNR after the packet combining for L-ary retransmissions ahead. This computation is useful to predict the number of retransmissions necessary to be within or above the AMC interval adapted to the AMC level of the packet.

Prediction methods can be used to estimate the channel from 1 to L step ahead, and the channel estimate can be used to compute the SNR.

The present invention provides a method that introduces a margin to the SNR. The SNR computation is based on the estimation of the variation of each link. When the channel is highly time varying, the CSI is independent in every frame. Hence, the following scheme is taken, wherein the AMC level is based on a long-term average SNR.

The selection between the AS mode and the SM mode is based on the long-term average SNR. When the channel is highly time varying, the retransmission in the SM mode is performed according to a Space Time Block Coding (STBC) based on the time.

It is assumed that the delay between two measurements at the MS is τ. The MS estimates the channel variation between the measurements separated by Lτ. The channel varies as follows:

$${Δ}_{L} = \frac{{E ( {\vert h ( t + L τ ) \vert}^{2} - {\vert h ( t ) \vert}^{2} )}^{2}}{{E ( {\vert h ( t ) \vert}^{2} )}^{2}} , \qquad 1 \leq L \leq {L}_{max} .$$

h(t) is a channel matrix of a single link. This measurement takes into account small-scale and large-scale variations, i.e., the variation of the energy of the channel, fading, or Doppler.

In computing the SNR obtained after the packet combining for L-ary retransmissions ahead in the SM mode and the AS mode, the receive data at the time t can be expressed as:

y(t)=H(t)X(t)+N(t), where H(t)=[H₁(t)H₂(t)].

Up to the time t, the receiver is aware of the channel coefficient H(t).

With the L-ary retransmissions ahead, the data is expressed as:

$${Y}^{( L )} ( t + L τ ) = {H}^{( L )} ( t + L τ ) X ( t + L τ ) + N ( t + L τ ) , \\ where {H}^{( L )} ( t + L τ ) = [ \begin{matrix}{H}_{1} ( t ) & {H}_{2} ( t ) \\ {H}_{1}^{( L )} ( t + L τ ) & {H}_{2}^{( L )} ( t + L τ )\end{matrix} ] and$$

$${H}_{i}^{( L )} ( t ) = [ \begin{matrix}{h}_{[ {\underline{X}}_{i} ]} ( t + τ ) \\ ⋮ \\ {h}_{[ {\underline{X}}_{i} ]} ( t + L τ )\end{matrix} ] .$$

The SNR in the SM mode is acquired as below.

The SNR at the output of the ZR equalizer for a stream i is

$$\begin{matrix}{SNR}_{i} = \frac{{σ}_{X}^{2}}{{{σ}_{N}^{2} [ {( {H}_{1}^{{( L )}^{H}} ( t + L τ ) {H}_{1}^{( L )} ( t + L τ ) )}^{- 1} ]}_{ii}} \\ = \frac{{σ}_{X}^{2} α ( L )}{{σ}_{N}^{2}} .\end{matrix}$$

$${α}_{i} ( L ) = {[ {( {H}_{1}^{{( L )}^{H}} ( t + L τ ) {H}_{1}^{( L )} ( t + L τ ) )}^{- 1} ]}_{ii}^{- 1}$$

$$and$$

$$\begin{matrix}{α}_{1} ( L ) = {P}_{{H}_{2}^{( L )} ( t + L τ )}^{⊥} {H}_{1}^{( P )} ( t + L τ ) \\ = {‖ {H}_{1} ( t ) ‖}^{2} + {‖ {H}_{1}^{( L )} ( t + L τ ) ‖}^{2} - \\ \frac{{\vert {H}_{1}^{H} ( t ) {H}_{2} ( t ) + {\sum }_{k = 1}^{L} {h}_{[ {\underline{X}}_{1} ]}^{H} ( t + k τ ) {h}_{[ {X}_{2} ]} ( t + k τ ) \vert}^{2}}{{‖ {H}_{2} ( t ) ‖}^{2} + {‖ {H}_{2}^{( L )} ( t + L τ ) ‖}^{2}} .\end{matrix}$$

P_{A}^{⊥}=I−P_{A}, and P_{A} is the orthogonal projection onto the column space of A.

The acquired α can be used to compute the SNR. Hereafter, the calculation of α is explained in detail.

In the above expression, the SNR with the margin is calculated as shown below.

∥H₁(t)∥², ∥H₂(t)∥² and ∥H₁^{H}(t)H₂(t)∥² can be computed using the channel estimates at the MS up to the time t as follows:

$${‖ {H}_{1}^{( L )} ( t + L τ ) ‖}^{2} = ( 1 + {\sum }_{k = 1}^{L} {Δ}_{k} ) {‖ {h}_{[ {X}_{1} ]} ( t ) ‖}^{2}$$

$${‖ {H}_{2}^{( L )} ( t + L τ ) ‖}^{2} = ( 1 + {\sum }_{k = 1}^{L} {Δ}_{k} ) {‖ {h}_{[ {\underline{X}}_{1} ]} ( t ) ‖}^{2}$$

$${\vert {H}_{1}^{H} ( t ) {H}_{2} ( t ) + {\sum }_{k = 1}^{L} {h}_{[ {\underline{X}}_{1} ]}^{H} ( t + k τ ) {h}_{[ {X}_{2} ]} ( t + k τ ) \vert}^{2} = {\vert {H}_{1}^{H} ( t ) {H}_{2} ( t ) \vert}^{2} + {\vert {\sum }_{k = 1}^{L} {h}_{[ {\underline{X}}_{1} ]}^{H} ( t + k τ ) {h}_{[ {X}_{2} ]} ( t + k τ ) \vert}^{2} + {C}_{1} ( t , … , t + τ )$$

$${\vert {\sum }_{k = 1}^{L} {h}_{[ {\underline{X}}_{1} ]}^{H} ( t + k τ ) {h}_{[ {X}_{2} ]} ( t + k τ ) \vert}^{2} = {\sum }_{k = 1}^{L} ( 1 - \frac{1}{2} {\sum }_{k = 1}^{L} {Δ}_{k} ) ( {\vert {h}_{11} ( t ) \vert}^{2} {\vert {h}_{21} ( t ) \vert}^{2} + {\vert {h}_{21} ( t ) \vert}^{2} {\vert {h}_{22} ( t ) \vert}^{2} ) + {C}_{2} ( t , … , t + τ )$$

C₁(t, . . . , t+τ) and C₂(t, . . . , t+τ) are cross terms for which the variation will be considered as negligible.

When one packet is erroneous at the time t, the AMC level of the newly transmitted packets is well adjusted. Consequently, the packets are decoded correctly.

It is assumed that hᵢ(t) is the channel of the retransmitting antenna at the time t and hⱼ(t) is another channel, and that the packet is retransmitted from the same antenna until a time t+Lτ. Herein, the scheme that maximizes the throughput retransmits the packet from the weakest antenna. It is assumed that the weakest antenna sustains the same L-step. The equivalent

$$ARQ channel is {H}^{( L )} ( t + L τ ) = [ \begin{matrix}{H}_{1} ( t ) & 0 \\ {H}_{1}^{( L )} ( t + ( L - 1 ) τ ) & 0 \\ {h}_{i}^{( L )} ( t + L τ ) & {h}_{j}^{( L )} ( t + L τ )\end{matrix} ] , \\ where$$

$${α}_{i} ( t + L τ ) = {‖ {H}_{1} ( t ) ‖}^{2} + ( 1 + {\sum }_{k = 1}^{L} {Δ}_{k} ) {‖ {h}_{i} ( t ) ‖}^{2} - \frac{\begin{matrix}{( 1 - \begin{matrix}1 \\ 2\end{matrix} {Δ}_{L} )}^{2} ( {\vert {h}_{11} ( t ) \vert}^{2} {\vert {h}_{21} ( t ) \vert}^{2} {\vert {h}_{21} ( t ) \vert}^{2} {\vert {h}_{22} ( t ) \vert}^{2} ) + \\ 2 Re ( {h}_{11}^{*} ( t ) {h}_{21} ( t ) {h}_{12}^{*} ( t ) {h}_{22} ( t ) )\end{matrix}}{( 1 + {Δ}_{L} ) {‖ {h}_{j} ( t ) ‖}^{2}}$$

$${α}_{j} ( t + L τ ) = ( 1 + {\sum }_{k = 1}^{L} {Δ}_{k} ) {‖ {h}_{j} ( t ) ‖}^{2} - \frac{\begin{matrix}{( 1 - \begin{matrix}1 \\ 2\end{matrix} {Δ}_{L} )}^{2} ( {\vert {h}_{11} ( t ) \vert}^{2} {\vert {h}_{21} ( t ) \vert}^{2} {\vert {h}_{21} ( t ) \vert}^{2} {\vert {h}_{22} ( t ) \vert}^{2} ) + \\ 2 Re ( {h}_{11}^{*} ( t ) {h}_{21} ( t ) {h}_{12}^{*} ( t ) {h}_{22} ( t ) )\end{matrix}}{{‖ {H}_{1} ( t ) ‖}^{2} + ( 1 + {Δ}_{L} ) {‖ {h}_{i} ( t ) ‖}^{2}} .$$

The time t+Lτ accounts for the margin by Lτ to the time t.

The SNR in the AS mode is now computed.

hₘₐₓ(t) is the channel of the strongest antenna at the time t. It is assumed that the strongest antenna sustains during the L-ary retransmissions.

At the time t, when only one packet is detected with error and the AS mode is selected, the equivalent matrix is

$${H}^{( L )} ( t + L τ ) = [ \begin{matrix}{H}_{j} ( t ) \\ \sqrt{2} {H}_{max}^{( L )} ( t + L τ )\end{matrix} ] ,$$

where j=1 or j=2.

Thus,

$$\begin{matrix}{α}_{max} ( t + L τ ) = {‖ {H}_{j} ( t ) ‖}^{2} + 2 {‖ {H}_{max}^{( L )} ‖}^{2} \\ = {‖ {H}_{j} ( t ) ‖}^{2} + 2 ( 1 + {\sum }_{k = 1}^{L} {Δ}_{k} ) {‖ {h}_{max} ( t ) ‖}^{2} .\end{matrix}$$

When two packets are erroneous and the AS mode is selected, the SNR corresponding to L₁ retransmissions of 1 packet from the strongest antenna and the SNR corresponding to L₂ retransmissions of the other packet are computed. The equivalent matrix is

$${H}^{( L )} ( t + L τ ) = [ \begin{matrix}{H}_{1} ( t ) & {H}_{2} ( t ) \\ 2 {H}_{max}^{( {L}_{1} )} ( t + L τ ) & 0 \\ 0 & 2 {H}_{max}^{( {L}_{1} )} ( t + L τ )\end{matrix} ] .$$

When the packet combining is complete,

$${α}_{max} ( t + L τ ) = {‖ {H}_{1} ( t ) ‖}^{2} + 2 ( 1 + {\sum }_{k = 1}^{{L}_{1}} {Δ}_{k} ) {‖ {h}_{max} ( t ) ‖}^{2} - \frac{{\vert {H}_{1}^{H} ( t ) {H}_{2} ( t ) \vert}^{2}}{{‖ {H}_{2} ( t ) ‖}^{2} + 2 ( 1 + {\sum }_{k = 1}^{{L}_{2}} {Δ}_{k} ) {‖ {h}_{max} ( t ) ‖}^{2}} .$$

Now, the retransmission scheme of the present invention is explained. First, one erroneous packet will be described.

As described earlier, it is assumed that the other stream is successfully transmitted for L times. Next, the best method for maximizing the throughput is to retransmit the packet from the weakest antenna.

However, the increase of SNR brought by each retransmission from the weakest antenna can be small and the number of necessary retransmissions may exceed the maximum number allowed. An alternative method is to retransmit from the strongest antenna.

Another alternative method, especially when the AMC level on both streams are different, is to transmit from the antenna which will result in the smallest normalized variance of the SNR for the target SNR of the retransmitted packet.

The smallest normalized variance of the SNR for the target SNR of the retransmitted packet is acquired as follows:

$${min}_{{possible}_{retransmissions}} \{ \frac{\vert {SNR}_{target} ( {m}_{i} ) - SNR ( {m}_{i} ) \vert}{{SNR}_{target} ( {m}_{i} )} \} .$$

SNR_{target}(mᵢ) is an inferior bound of the adapted AMC interval, and SNR(mᵢ) is the SNR of the packet i with the AMC level mᵢ.

Two erroneous packets will now be explained.

First, the two packets have the same AMC level.

In this case, the best method for maximizing the throughput is the retransmission that equalizes the SNR of both streams after the ZF equalization. Second, the two packets have different AMC levels.

As the two packets have the different AMC levels, the retransmissions should not try to equalize the SNRs. Instead, the retransmissions normalize the variation of the SNR for the target SNR.

The SNR is equalized as

$$\frac{\vert {SNR}_{target} ( {m}_{i} ) - SNR ( {m}_{i} ) \vert}{{SNR}_{target} ( {m}_{i} )} .$$

SNR_{target}(mᵢ) is the inferior bound of the adapted AMC interval, and SNR(mᵢ) is the SNR of the packet i with the AMC level mᵢ.

An alternative method is expressed as

$${min}_{{possible}_{retransmissions}} \{ \frac{\vert {SNR}_{target} ( {b}_{1} ) - SNR ( {b}_{1} ) \vert}{{SNR}_{target} ( {b}_{1} )} + \frac{\vert {SNR}_{target} ( {b}_{2} ) - SNR ( {b}_{2} ) \vert}{{SNR}_{target} ( {b}_{2} )} \} .$$

b₁ relates to the packet 1 and b₂ relates to the packet 2.

In general, such a method provides different results as compared to the method applied in which the AMC levels are the same on both streams. If the SNRs of both streams are too low for the chosen AMC levels, the sending of the packet with a higher AMC level from the weakest antenna may represent too small additional increase of the SNR. If the packet with the lowest AMC level is sent from the strongest antenna, it may be too large additional increase of the SNR. As a result, resources are lost and throughput is not maximized. In general, packets will be retransmitted from the same antenna.

Furthermore, the retransmissions will be performed so that the streams are as orthogonal as possible. If X₁(t) and X₂(t) are sent from an antenna 1 and an antenna 2 respectively, according to the retransmission decision, −X₁(t) and X₂(t) or −X₂*(t) and X₁*(t) should be retransmitted from the antenna 1 and the antenna 2.

Hereafter, the ARQ mechanism of the present invention will be described in detail.

The adaptive modulation is conducted on both streams.

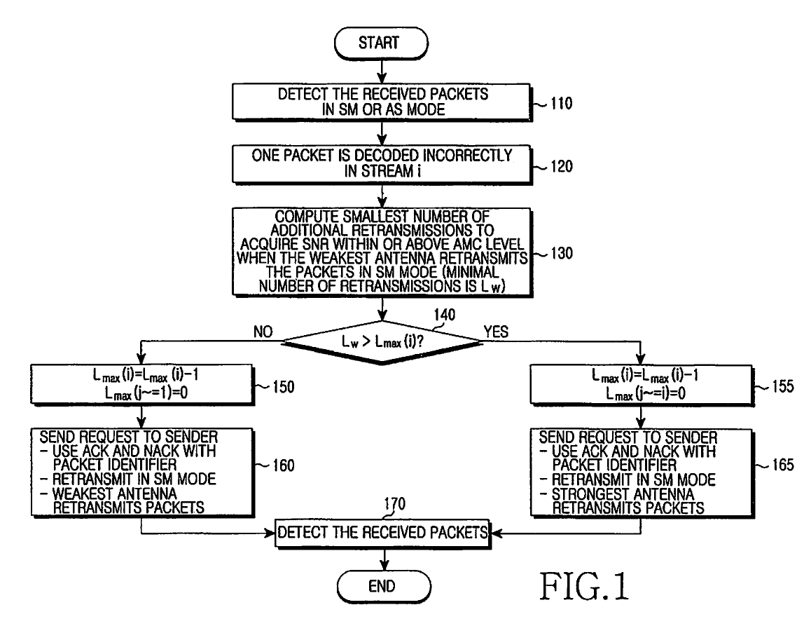

First, a description of FIG. 1 will be given, wherein one packet is detected with an error.

FIG. 1 is a flowchart illustrating a retransmission method of a user terminal according to an embodiment of the present invention. The minimal number of retransmissions from the weakest antenna is computed to acquire an SNR. The SNR is within or above the AMC interval adapted to the AMC level of the packet in error. When the minimal number is greater than the maximum number, the next retransmission is done from the weakest antenna. A new packet is retransmitted from the other antenna, with an appropriate AMC level.

Referring to FIG. 1, the terminal detects the received packets in the SM mode or the AS mode in step 10, and detects one erroneous packet in the stream i including the received packets in step 120.

When the erroneous packet is received from the weakest antenna in the SM mode, the terminal computes the smallest number of additional retransmissions to acquire the SNR within or above the AMC level in step 130.

When the smallest number of the retransmissions is greater than a specific threshold Lₘₐₓ(i) in step 140, the terminal performs a specific operation, e.g., reduces the threshold by one in step 155. Thereafter, in step 165, the terminal requests the BS to retransmit the packets from the strongest antenna in the SM mode.

However, when the smallest number of the retransmissions is smaller than the threshold Lₘₐₓ(i) in step 140, the terminal reduces the threshold by one in step 150 and requests the BS to retransmit the packets from the weakest antenna in the SM mode in step 160. In the retransmissions, ACK and NACK can be used.

After either step 160 or 165, the terminal detects the received packets in step 170 and then finishes this process.

When two packets are detected with error, they are retransmitted.

At this time, the adaptive modulation and the antenna selection are possible.

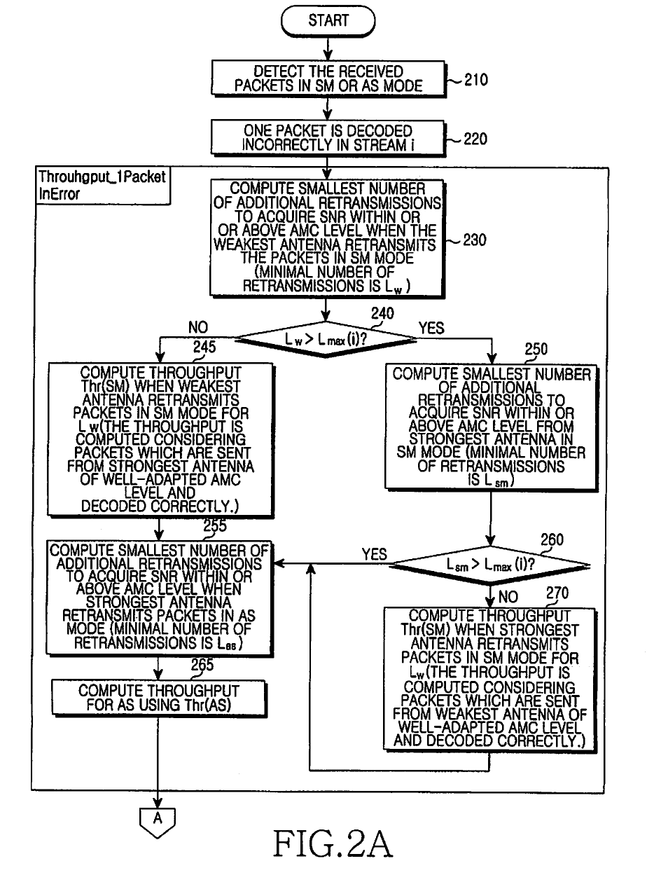

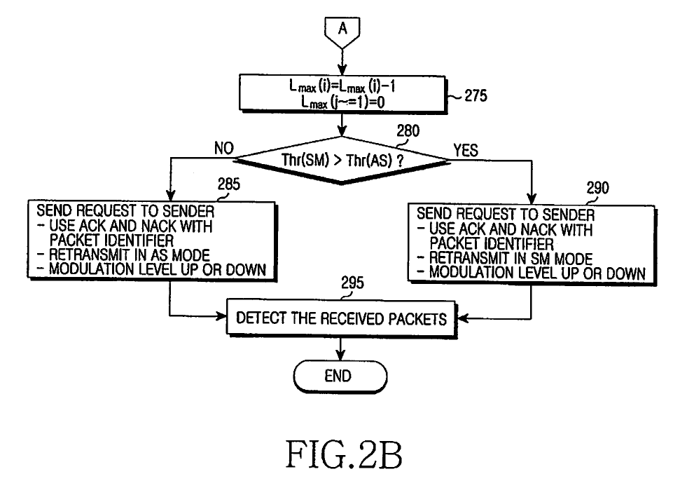

FIGS. 2A and 2B are flowcharts of a retransmission method of a user terminal according to an embodiment of the present invention. As was done for FIG. 1 above, FIGS. 2A and 2B will be described using the example of when one packet is erroneous. The minimal number of retransmissions from the weakest antenna is computed to acquire a resulting SNR. The SNR is within or above the AMC interval adapted to the AMC level of the packet in error. If the minimal number is greater than the maximum number, the minimal number of retransmissions from the stronger antenna is computed to acquire the SNR. The SNR is within or above the AMC interval adapted to the AMC level of the packet in error. When the minimal number of the retransmissions from the stronger antenna is equal to the maximum number, the throughput for the antenna selection is computed. When the SM exhibits the best throughput, the next retransmission is performed from the selected antenna. A new packet is retransmitted from the other antenna, with appropriate AMC level. Otherwise, the next retransmission is carried out from the strongest antenna with twice the power.

Referring FIGS. 2A and 2B, the terminal detects the received packets in the SM mode or the AS mode in step 210, and discovers one erroneous packet in the stream i of the received packets in step 220.

The erroneous packet is received from the weakest antenna in the SM mode, the terminal computes the smallest number of additional retransmissions to acquire the SNR within or above the AMC level in step 230.

When the smallest number of the retransmissions is greater than a threshold Lₘₐₓ(i) in step 240, the terminal computes the smallest number of additional retransmissions Lₛₘ to acquire the SNR within or above the AMC level when the strongest antenna retransmits the packets in the SM mode in step 250.

Further, when the smallest number of the retransmissions Lₛₘ is smaller than the threshold Lₘₐₓ(i) in step 260, the terminal computes the throughput Thr(sm) of the retransmission from the strongest antenna in the SM mode in step 270 and then proceeds to step 255.

However, when the smallest number of the retransmissions is smaller than the threshold Lₘₐₓ(i) in step 240, the terminal computes the throughput Thr(sm) for the smallest number of the additional retransmissions Lₛₘ in the retransmission from the weakest antenna in the SM mode in step 245.

After step 245, step 270, or when the smallest number of the retransmissions Lₛₘ is greater than the threshold Lₘₐₓ(i) in step 260, the terminal computes the smallest number of additional retransmissions Lₐₛ to acquire the SNR within or above the AMC level in the retransmission from the strongest antenna in the AS mode in step 255, and computes the throughput Thr(AS) for the AS in step 265.

Referring to FIG. 2B, the terminal reduces the threshold by one in step 275, and compares the throughput of the AS mode and the throughput of the SM mode in step 280.

When the throughput of the SM mode is greater in step 280, the terminal requests the retransmission in the SM mode to the BS in step 290. However, when the throughput of the AS mode is greater, the terminal requests the retransmission in the AS mode to the BS in step 285. Thereafter, the received packets are detected in step 295.

In the retransmissions, ACK and NACK can be used and the modulation level can be increased or decreased.

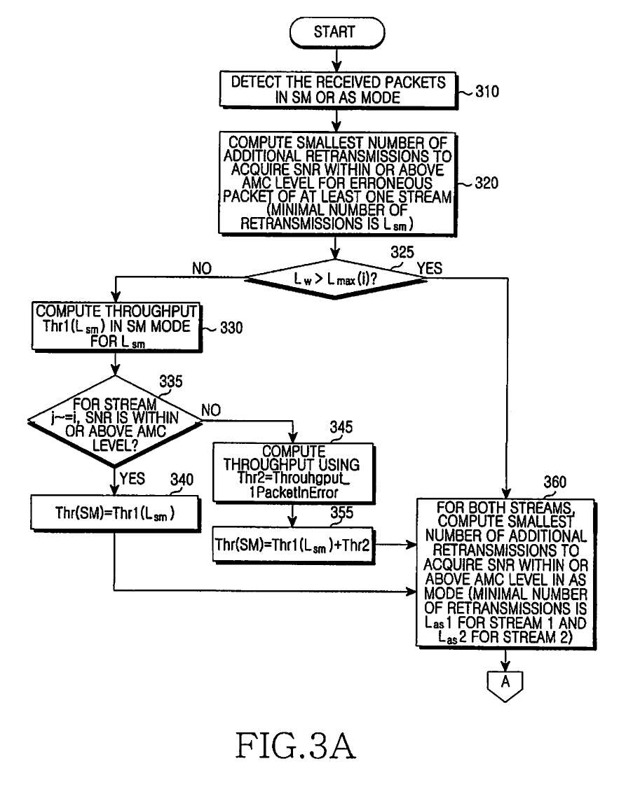

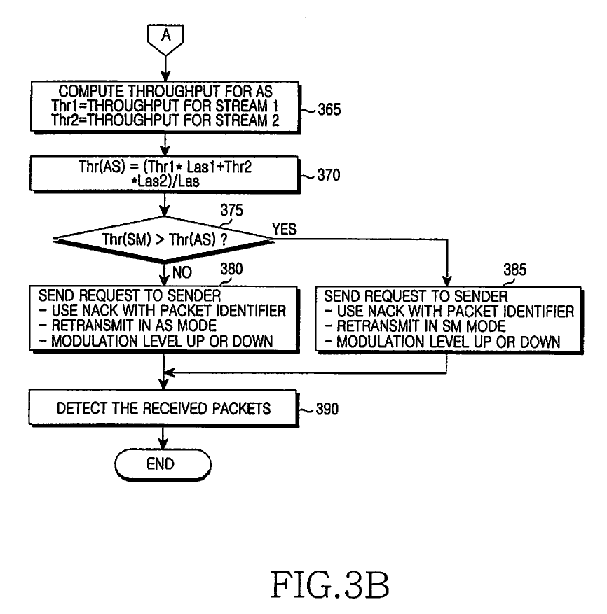

FIGS. 3A and 3B are flowcharts of a retransmission method of a user terminal according to an embodiment of the present invention. Unlike the embodiments described above with reference to FIGS. 1, 2A, and 2B, the embodiment described in FIGS. 3A and 3B will be described using the example wherein two packets are detected with error.

Basically, the terminal computes the minimal number of retransmissions for correctly decoding at least 1 packet. If the other packet is not decoded correctly after the minimal number of retransmissions, the throughput is computed as illustrated in FIGS. 2A and 2B. If the minimal number exceeds the allowed number after the transition to the AS mode, the retransmission is performed until one packet is correctly decoded. This applies to the other packet. Otherwise, the throughput in the SM mode is compared with the throughput in the AS mode.

Referring to FIGS. 3A and 3B, the terminal detects the received packets in the SM mode or the AS mode and discovers two erroneous packets in the received packets in step 310. In step 320, the terminal computes the smallest number of additional retransmissions to acquire the SNR within or above the AMC level for recovering at least one stream packet in error.

When the smallest number of the additional retransmissions Lₛₘ is greater than a threshold Lₘₐₓ(i) in step 325, the terminal computes the smallest number of retransmissions to acquire the SNR within or above the AMC level in the AS mode with respect to both streams Las1 and Las2 in step 360.

The terminal computes the throughputs for the both streams Last and Las2 in the AS mode in step 365, and computes the throughput for the AS mode from the computed throughputs in step 370.

However, when the smallest number of the retransmissions Lₛₘ is smaller than the threshold Lₘₐₓ(i) in step 325, the terminal computes the throughput Thr1(Lsm) for the smallest number of the retransmissions Lₛₘ with respect to one stream in the SM mode in step 330.

When the SNR of the other stream (j˜=i) is within or above the AMC level in step 335, the terminal sets the throughput Thr1(Lsm) computed in step 330 as the throughput Thr(SM) of the SM mode in step 340. However, when the SNR of the other stream (j˜=i) is not within or above the AMC level in step 335, the terminal computes the throughput Thr2 for the other stream in step 345 as illustrated in FIGS. 2A and 2B.

In step 355, the terminal sets the sum of the throughput Thr2 computed in step 345 and the throughput Thr1(Lsm) computed in step 330 as the throughput Thr(SM) of the SM mode.

After computing the throughput Thr(SM) of the SM mode, the terminal computes the throughput Thr(AS) of the AS mode in steps 360 through 370.

Referring to FIG. 3B, in step 375, the terminal compares the throughout Thr(SM) of the SM mode with the throughput Thr(AS) of the AS mode. When the throughput of the AS mode is greater, the terminal requests the retransmission in the AS mode from the BS in step 380. However, when the throughput of the SM mode is greater, the terminal requests the retransmission in the SM mode from the BS in step 385.

In the retransmissions, ACK and NACK can be used. Also, the modulation level can be increased or decreased.

Thereafter, in step 390, the received packets are detected.

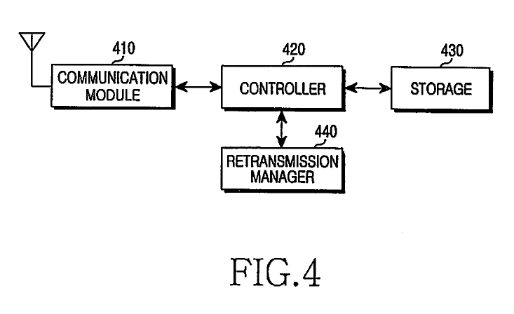

FIG. 4 is a block diagram illustrating a wireless terminal and a network device according to an embodiment of the present invention.

Referring to FIG. 4, for the wireless terminal, a communication module 410 includes a wireless processing module and a baseband processing module for communicating with other nodes. The wireless processing module converts a signal received on an antenna to a baseband signal and provides the baseband signal to the baseband processing module, and converts a baseband signal output from the baseband processing module to a Radio Frequency (RF) signal transmittable over the air and transmits the RF signal over the antenna.

A controller 420 performs basic processing and controlling of the terminal. For example, the controller 420 processes and controls voice communications and data communications. In addition to its typical functions, the controller 420 controls a retransmission manager 440 to measure the SNR considering the margin, to compute the minimal number of the retransmissions, and to select the retransmissions in the AS mode or the SM mode.

Storage 430 stores programs for controlling the operations of the terminal and temporary data generating in the program executions.

The retransmission manager 440 measures the SNR considering the margin, computes the minimal number of the retransmissions, and selects the retransmissions in the AS mode or the SM mode according to the direction and the information provided from the controller 420.

For the network device, a communication module 410 includes a wired processing module, a wireless processing module, and a baseband processing module for communicating with other nodes. The wireless processing module converts a signal received on an antenna to a baseband signal and provides the baseband signal to the baseband processing module, and converts a baseband signal output from the baseband processing module to a Radio Frequency (RF) signal transmittable over the air and transmits the RF signal over the antenna. The wired processing module receives a signal to be sent over the network from the baseband processing module, converts the signal according to a wired signal protocol, and then transmits the converted signal, or vice versa.

A controller 420 performs basic processing and controlling of the network device. For example, the controller 420 processes and controls voice communications and data communications. In addition to typical functions, the controller 420 controls a retransmission manager 440 to determine the AMC level of data to be transmitted, based on the SNR received from the terminal.

Storage 430 stores programs for controlling the operations of the network device and temporary data generating in the program executions.

The retransmission manager 440 determines the AMC level of data to be transmitted, based on the SNR received from the terminal according to the direction and the information provided from the controller 420.

As constructed above, the controller 420 can function as the retransmission manager 440. In this embodiment of the present invention, the controller 420 and the retransmission manager 440 are separately provided to distinguish their functions. In the actual implementation, the controller 420 can process all or part of the functions of the retransmission manager 440.

As set forth above, the number of retransmissions and the retransmission in either mode are determined in consideration of the SNR measured at the MS with the margin. As a result, the best antenna is selected for the retransmission based on the CSI, thereby, enhancing performance.

While the present invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method for an Automatic Repeat reQuest (ARQ) at a receiver in a Multiple Input Multiple Output (MIMO) system, the method comprising:
receiving packets from a sender;
when a received packet is erroneous and received from a weakest antenna in a Space Multiplexing (SM) mode, computing a first smallest number of retransmissions to acquire a Signal to Noise Ratio (SNR) within or above an Adaptive Modulation and Coding (AMC) level;
when the first smallest number of the retransmissions is greater than a threshold, requesting the sender to retransmit the packets from a strongest antenna in the SM mode; and
when the first smallest number of the retransmissions is smaller than the threshold, requesting the sender to retransmit the packets from a weakest antenna in the SM mode.

2. The method of claim 1, further comprising the step of adjusting a modulation level for a stream of each antenna.

3. The method of claim 1, wherein the SNR within or above the AMC level is expressed by:
$${SNR}_{i} = \frac{{σ}_{X}^{2}}{{{σ}_{N}^{2} [ {( {H}_{1}^{{( L )}^{H}} ( t + L τ ) {H}_{1}^{( L )} ( t + L τ ) )}^{- 1} ]}_{ii}} = \frac{{σ}_{X}^{2} α ( L )}{{σ}_{N}^{2}}$$
$$where$$
$${α}_{i} ( L ) = {[ {( {H}_{1}^{{( L )}^{H}} ( t + L τ ) {H}_{1}^{( L )} ( t + L τ ) )}^{- 1} ]}_{ii}^{- 1} , \\ \begin{matrix}{α}_{1} ( L ) = {P}_{{H}_{2}^{( L )} ( t + l , τ )}^{\underline{1}} {H}_{1}^{( P )} ( t + L τ ) \\ = {‖ {H}_{1} ( t ) ‖}^{2} + {‖ {H}_{1}^{( L )} ( t + L τ ) ‖}^{2} - \\ \frac{{\vert {H}_{1}^{H} ( t ) {H}_{2} ( t ) + {\sum }_{k = 1}^{L} {h}_{[ {X}_{1} ]}^{H} ( t + k τ ) {h}_{[ {X}_{2} ]} ( t + k τ ) \vert}^{2}}{{‖ {H}_{2} ( t ) ‖}^{2} + {‖ {H}_{2}^{( L )} ( t + L τ ) ‖}^{2}}\end{matrix}$$
where P_{A}^{⊥}=I−P_{A} and P_{A} is an orthogonal projection onto a column space of A, and when a margin is considered,
$${α}_{1} ( t + L τ ) = {‖ {H}_{1} ( t ) ‖}^{2} + ( 1 + {\sum }_{{}^{′} k = 1}^{L} {Δ}_{k} ) {‖ {h}_{i} ( t ) ‖}^{2} - \frac{\begin{matrix}{( 1 - \frac{1}{2} {Δ}_{L} )}^{2} ( {\vert {h}_{11} ( t ) \vert}^{2} {\vert {h}_{21} ( t ) \vert}^{2} {\vert {h}_{21} ( t ) \vert}^{2} {\vert {h}_{22} ( t ) \vert}^{2} ) + \\ 2 Re ( {h}_{11}^{*} ( t ) {h}_{21} ( t ) {h}_{12}^{*} ( t ) {h}_{22} ( t ) )\end{matrix}}{( 1 + {Δ}_{L} ) {‖ {h}_{j} ( t ) ‖}^{2}}$$
$$and$$
$${α}_{j} ( t + L τ ) = ( 1 + {\sum }_{{}^{′} k = 1}^{L} {Δ}_{k} ) {‖ {h}_{j} ( t ) ‖}^{2} - \frac{\begin{matrix}{( 1 - \frac{1}{2} {Δ}_{L} )}^{2} ( {\vert {h}_{11} ( t ) \vert}^{2} {\vert {h}_{21} ( t ) \vert}^{2} {\vert {h}_{21} ( t ) \vert}^{2} {\vert {h}_{22} ( t ) \vert}^{2} ) + \\ 2 Re ( {h}_{11}^{*} ( t ) {h}_{21} ( t ) {h}_{12}^{*} ( t ) {h}_{22} ( t ) )\end{matrix}}{{‖ {H}_{1} ( t ) ‖}^{2} + ( 1 + {Δ}_{L} ) {‖ {h}_{i} ( t ) ‖}^{2}} ,$$
where t+Lτ accounts for the margin by Lτ to the time t.

4. A method for an Automatic Repeat reQuest (ARQ) at a receiver in a Multiple Input Multiple Output (MIMO) system, the method comprising:
receiving packets from a sender;
when a received packet is erroneous and received from a weakest antenna in a Space Multiplexing (SM) mode, computing a first throughput of the SM mode and a second throughput of an Antenna Selection (AS) mode for the erroneous packet;
when the first throughput is greater than the second throughput, requesting retransmission of the packets in the SM mode; and
when the first throughput is smaller than the second throughput, requesting retransmission of the packets in the AS mode.

5. The method of claim 4, further comprising the steps of:
adjusting a modulation level for a stream of each antenna; and
selecting an antenna.

6. The method of claim 4, wherein the step of computing the first throughput of the SM mode and the second throughput of the AS mode for the erroneous packet comprises:
computing a first smallest number of additional retransmissions to acquire a Signal to Noise Ratio (SNR) within or above an Adaptive Modulation and Coding (AMC) level when the erroneous packet is received from the weakest antenna in the SM mode;
when the first smallest number of the additional retransmissions is greater than a threshold, computing a second smallest number of additional retransmissions to acquire an SNR within or above the AMC level when a strongest antenna retransmits the packets in the SM mode;
when the second smallest number of the additional retransmissions is smaller than the threshold, computing a third throughput when the strongest antenna retransmits the packets in the SM mode;
when the first smallest number of the additional retransmissions is smaller than the threshold, computing a fourth throughput for the first smallest number of the additional retransmissions; and
when the second smallest number of the additional retransmissions is greater than the threshold, or after computing the third throughput or computing the fourth throughput, computing a third smallest number of additional retransmissions to acquire the SNR within or above the AMC level when the strongest antenna retransmits the packets in the AS mode, and computing a fifth throughput.

7. The method of claim 6, wherein the fifth throughput is equal to the second throughput,
the third throughput is equal to the first throughput, when the second smallest number of the additional retransmissions is smaller than the threshold, and
the fourth throughput is equal to the second throughput, when the first smallest number of the additional retransmissions is smaller than the threshold.

8. The method of claim 6, wherein the SNR within or above the AMC level in the SM mode is expressed by:
$${SNR}_{i} = \frac{{σ}_{X}^{2}}{{{σ}_{N}^{2} [ {( {H}_{1}^{{( L )}^{H}} ( t + L τ ) {H}_{1}^{( L )} ( t + L τ ) )}^{- 1} ]}_{ii}} = \frac{{σ}_{X}^{2} α ( L )}{{σ}_{N}^{2}}$$
$$where$$
$${α}_{i} ( L ) = {[ {( {H}_{1}^{{( L )}^{H}} ( t + L τ ) {H}_{1}^{( L )} ( t + L τ ) )}^{- 1} ]}_{ii}^{- 1} , \\ \begin{matrix}{α}_{1} ( L ) = {P}_{{H}_{2}^{( L )} ( t + l , τ )}^{\underline{1}} {H}_{1}^{( P )} ( t + L τ ) \\ = {‖ {H}_{i} ( t ) ‖}^{2} + {‖ {H}_{1}^{( L )} ( t + L τ ) ‖}^{2} - \\ \frac{{\vert {H}_{1}^{H} ( t ) {H}_{2} ( t ) + {\sum }_{k = 1}^{L} {h}_{[ {X}_{1} ]}^{H} ( t + k τ ) {h}_{[ {X}_{2} ]} ( t + k τ ) \vert}^{2}}{{‖ {H}_{2} ( t ) ‖}^{2} + {‖ {H}_{2}^{( L )} ( t + L τ ) ‖}^{2}}\end{matrix}$$
where P_{A}^{⊥}=I−P_{A} and P_{A} is an orthogonal projection onto a column space of A, and
when a margin is considered,
$${α}_{1} ( t + L τ ) = {‖ {H}_{1} ( t ) ‖}^{2} + ( 1 + {\sum }_{{}^{′} k = 1}^{L} {Δ}_{k} ) {‖ {h}_{i} ( t ) ‖}^{2} - \frac{\begin{matrix}{( 1 - \frac{1}{2} {Δ}_{L} )}^{2} ( {\vert {h}_{11} ( t ) \vert}^{2} {\vert {h}_{21} ( t ) \vert}^{2} {\vert {h}_{21} ( t ) \vert}^{2} {\vert {h}_{22} ( t ) \vert}^{2} ) + \\ 2 Re ( {h}_{11}^{*} ( t ) {h}_{21} ( t ) {h}_{12}^{*} ( t ) {h}_{22} ( t ) )\end{matrix}}{( 1 + {Δ}_{L} ) {‖ {h}_{j} ( t ) ‖}^{2}}$$
$$and$$
$${α}_{j} ( t + L τ ) = ( 1 + {\sum }_{{}^{′} k = 1}^{L} {Δ}_{k} ) {‖ {h}_{j} ( t ) ‖}^{2} - \frac{\begin{matrix}{( 1 - \frac{1}{2} {Δ}_{L} )}^{2} ( {\vert {h}_{11} ( t ) \vert}^{2} {\vert {h}_{21} ( t ) \vert}^{2} {\vert {h}_{21} ( t ) \vert}^{2} {\vert {h}_{22} ( t ) \vert}^{2} ) + \\ 2 Re ( {h}_{11}^{*} ( t ) {h}_{21} ( t ) {h}_{12}^{*} ( t ) {h}_{22} ( t ) )\end{matrix}}{{‖ {H}_{1} ( t ) ‖}^{2} + ( 1 + {Δ}_{L} ) {‖ {h}_{i} ( t ) ‖}^{2}} ,$$
where t+Lτ takes into account the margin by Lτ to the time t.

9. A method for an Automatic Repeat reQuest (ARQ) at a receiver in a Multiple Input Multiple Output (MIMO) system, the method comprising:
receiving packets included in first and second streams from a sender;
when two of the received packets are erroneous, computing a first smallest number of additional retransmissions to acquire a Signal to Noise Ratio (SNR) within or above an Adaptive Modulation and Coding (AMC) level for correcting an error of at least one of the erroneous received packets;
when the first smallest number of the transmissions is greater than a threshold, computing a second smallest number of retransmissions to acquire an SNR within or above the AMC level in an Antenna Selection (AS) mode for the two streams; and
computing a throughput in the AS mode.

10. The method of claim 9, further comprising:
when the first smallest number of the retransmissions is smaller than the threshold, computing a second throughput for the first smallest number of the retransmissions with respect to the first stream in a Space Multiplexing (SM) mode;
when an SNR of the second stream is within or above the AMC level, setting the second smallest throughput as a throughput of the SM mode;
when the SNR of the second stream is not within or above the AMC level, computing a third throughput for the second stream;
setting a sum of the third throughput and the second throughput as a throughput of the SM mode;
comparing the throughput of the SM mode with the throughput of the AS mode;
when the throughput of the AS mode is greater, requesting the retransmission of the AS mode; and
when the throughput of the AS mode is smaller, requesting the retransmission of the SM mode.

11. The method of claim 10, further comprising the steps of:
adjusting a modulation level for a stream of each antenna; and
selecting an antenna.

12. The method of claim 10, wherein the computing of the throughput in the AS mode, after acquiring the second number of the retransmissions, comprises:
computing throughputs for the two streams, respectively; and
adding products of the throughputs and the second number of the retransmissions.

13. The method of claim 10, wherein the SNR within or above the AMC level in the SM mode is expressed by:
$${SNR}_{i} = \frac{{σ}_{X}^{2}}{{{σ}_{N}^{2} [ {( {H}_{1}^{{( L )}^{H}} ( t + L τ ) {H}_{1}^{( L )} ( t + L τ ) )}^{- 1} ]}_{ii}} = \frac{{σ}_{X}^{2} α ( L )}{{σ}_{N}^{2}}$$
$$where$$
$${α}_{i} ( L ) = {[ {( {H}_{1}^{{( L )}^{H}} ( t + L τ ) {H}_{1}^{( L )} ( t + L τ ) )}^{- 1} ]}_{ii}^{- 1} , \\ \begin{matrix}{α}_{1} ( L ) = {P}_{{H}_{2}^{( L )} ( t + l , τ )}^{\underline{1}} {H}_{1}^{( P )} ( t + L τ ) \\ = {‖ {H}_{i} ( t ) ‖}^{2} + {‖ {H}_{1}^{( L )} ( t + L τ ) ‖}^{2} - \\ \frac{{\vert {H}_{1}^{H} ( t ) {H}_{2} ( t ) + {\sum }_{k = 1}^{L} {h}_{[ {X}_{1} ]}^{H} ( t + k τ ) {h}_{[ {X}_{2} ]} ( t + k τ ) \vert}^{2}}{{‖ {H}_{2} ( t ) ‖}^{2} + {‖ {H}_{2}^{( L )} ( t + L τ ) ‖}^{2}} .\end{matrix}$$
where P_{A}^{⊥}=I−P_{A} and P_{A} is an orthogonal projection onto a column space of A, and
when a margin is considered,
$${α}_{1} ( t + L τ ) = {‖ {H}_{1} ( t ) ‖}^{2} + ( 1 + {\sum }_{{}^{′} k = 1}^{L} {Δ}_{k} ) {‖ {h}_{i} ( t ) ‖}^{2} - \frac{\begin{matrix}{( 1 - \frac{1}{2} {Δ}_{L} )}^{2} ( {\vert {h}_{11} ( t ) \vert}^{2} {\vert {h}_{21} ( t ) \vert}^{2} {\vert {h}_{21} ( t ) \vert}^{2} {\vert {h}_{22} ( t ) \vert}^{2} ) + \\ 2 Re ( {h}_{11}^{*} ( t ) {h}_{21} ( t ) {h}_{12}^{*} ( t ) {h}_{22} ( t ) )\end{matrix}}{( 1 + {Δ}_{L} ) {‖ {h}_{j} ( t ) ‖}^{2}}$$
$$and$$
$${α}_{j} ( t + L τ ) = ( 1 + {\sum }_{{}^{′} k = 1}^{L} {Δ}_{k} ) {‖ {h}_{j} ( t ) ‖}^{2} - \frac{\begin{matrix}{( 1 - \frac{1}{2} {Δ}_{L} )}^{2} ( {\vert {h}_{11} ( t ) \vert}^{2} {\vert {h}_{21} ( t ) \vert}^{2} {\vert {h}_{21} ( t ) \vert}^{2} {\vert {h}_{22} ( t ) \vert}^{2} ) + \\ 2 Re ( {h}_{11}^{*} ( t ) {h}_{21} ( t ) {h}_{12}^{*} ( t ) {h}_{22} ( t ) )\end{matrix}}{{‖ {H}_{1} ( t ) ‖}^{2} + ( 1 + {Δ}_{L} ) {‖ {h}_{i} ( t ) ‖}^{2}} ,$$
where t+Lτ takes into account the margin by Lτ to the time t.

14. A receiver for an Automatic Repeat reQuest (ARQ) in a Multiple Input Multiple Output (MIMO system, comprising:
a communication module having a plurality of antennas for communicating with multiple nodes; and
a controller for receiving packets from a sender through the communication module, computing a first smallest number of retransmissions to acquire a Signal to Noise Ratio (SNR) within or above an Adaptive Modulation and Coding (AMC) level when one of the packets is erroneous and is received from a weakest antenna in a Space Multiplexing (SM) mode, requesting the sender to retransmit the packets from a strongest antenna in the SM mode when the first smallest number of the retransmissions is greater than a threshold, and requesting the sender to retransmit the packets from the weakest antenna in the SM mode when the first smallest number of the retransmissions is smaller than the threshold.

15. The receiver of claim 14, wherein the MIMO system adjusts a modulation level for a stream of each antenna.

16. The receiver of claim 14, wherein the SNR within or above the AMC level is expressed by:
$${SNR}_{i} = \frac{{σ}_{X}^{2}}{{{σ}_{N}^{2} [ {( {H}_{1}^{{( L )}^{H}} ( t + L τ ) {H}_{1}^{( L )} ( t + L τ ) )}^{- 1} ]}_{ii}} = \frac{{σ}_{X}^{2} α ( L )}{{σ}_{N}^{2}}$$
$$where$$
$${α}_{i} ( L ) = {[ {( {H}_{1}^{{( L )}^{H}} ( t + L τ ) {H}_{1}^{( L )} ( t + L τ ) )}^{- 1} ]}_{ii}^{- 1} , \\ \begin{matrix}{α}_{1} ( L ) = {P}_{{H}_{2}^{( L )} ( t + l , τ )}^{\underline{1}} {H}_{1}^{( P )} ( t + L τ ) \\ = {‖ {H}_{i} ( t ) ‖}^{2} + {‖ {H}_{1}^{( L )} ( t + L τ ) ‖}^{2} - \\ \frac{{\vert {H}_{1}^{H} ( t ) {H}_{2} ( t ) + {\sum }_{k = 1}^{L} {h}_{[ {X}_{1} ]}^{H} ( t + k τ ) {h}_{[ {X}_{2} ]} ( t + k τ ) \vert}^{2}}{{‖ {H}_{2} ( t ) ‖}^{2} + {‖ {H}_{2}^{( L )} ( t + L τ ) ‖}^{2}}\end{matrix}$$
where P_{A}^{⊥}=I−P_{A} and P_{A} is an orthogonal projection onto a column space of A, and
when a margin is considered,
$${α}_{1} ( t + L τ ) = {‖ {H}_{1} ( t ) ‖}^{2} + ( 1 + {\sum }_{{}^{′} k = 1}^{L} {Δ}_{k} ) {‖ {h}_{i} ( t ) ‖}^{2} - \frac{\begin{matrix}{( 1 - \frac{1}{2} {Δ}_{L} )}^{2} ( {\vert {h}_{11} ( t ) \vert}^{2} {\vert {h}_{21} ( t ) \vert}^{2} {\vert {h}_{21} ( t ) \vert}^{2} {\vert {h}_{22} ( t ) \vert}^{2} ) + \\ 2 Re ( {h}_{11}^{*} ( t ) {h}_{21} ( t ) {h}_{12}^{*} ( t ) {h}_{22} ( t ) )\end{matrix}}{( 1 + {Δ}_{L} ) {‖ {h}_{j} ( t ) ‖}^{2}}$$
$$and$$
$${α}_{j} ( t + L τ ) = ( 1 + {\sum }_{{}^{′} k = 1}^{L} {Δ}_{k} ) {‖ {h}_{j} ( t ) ‖}^{2} - \frac{\begin{matrix}{( 1 - \frac{1}{2} {Δ}_{L} )}^{2} ( {\vert {h}_{11} ( t ) \vert}^{2} {\vert {h}_{21} ( t ) \vert}^{2} {\vert {h}_{21} ( t ) \vert}^{2} {\vert {h}_{22} ( t ) \vert}^{2} ) + \\ 2 Re ( {h}_{11}^{*} ( t ) {h}_{21} ( t ) {h}_{12}^{*} ( t ) {h}_{22} ( t ) )\end{matrix}}{{‖ {H}_{1} ( t ) ‖}^{2} + ( 1 + {Δ}_{L} ) {‖ {h}_{i} ( t ) ‖}^{2}} ,$$
where i+Lτ takes into account the margin by Lτ to the time t.

17. A receiver for an Automatic Repeat reQuest (ARQ) in a Multiple Input Multiple Output (MIMO) system, comprising:
a communication module having a plurality of antennas for communicating with multiple nodes; and
a controller for
receiving packets from a sender through the communication module,
computing a first throughput of a Space Multiplexing (SM) mode and a second throughput of an Antenna Selection (AS) mode for the erroneous packet, when one of the packets is erroneous and is received from a weakest antenna in the SM mode,
requesting to retransmit the packets in the SM mode, when the first throughput is greater than the second throughput, and
requesting to retransmit the packets in the AS mode, when the first throughput is smaller than the second throughput.

18. The receiver of claim 17, wherein the MIMO system adjusts a modulation level for a stream of each antenna, and selects an antenna.

19. The receiver of claim 17, wherein the controller computes the first throughput by computing a first smallest number of additional retransmissions to acquire a Signal to Noise Ratio (SNR) within or above an Adaptive Modulation and Coding (AMC) level when the erroneous packet is received from the weakest antenna in the SM mode,
computing a second smallest number of additional retransmissions to acquire an SNR within or above the AMC level when the strongest antenna retransmits the packets in the SM mode, when the first smallest number of the additional retransmissions is greater than a threshold,
computing a third throughput when the strongest antenna retransmits the packets in the SM mode, when the second smallest number of the additional retransmissions is smaller than the threshold,
computing a fourth throughput for the first smallest number of the additional retransmissions, when the first smallest number of the additional retransmissions is smaller than the threshold, and
computing a third smallest number of additional retransmissions to acquire the SNR within or above the AMC level when the strongest antenna retransmits the packets in the AS mode, and a computing fifth throughput, when the second smallest number of the additional retransmissions is greater than the threshold, or after computing the third throughput or computing the fourth throughput.

20. The receiver of claim 19, wherein the fifth throughput is equal to the second throughput,
the third throughput is equal to the first throughput when the second smallest number of the additional retransmissions is smaller than the threshold, and
the fourth throughput is equal to the second throughput when the first smallest number of the additional retransmissions is smaller than the threshold.

21. The receiver of claim 17, wherein the SNR within or above the AMC level in the SM mode is expressed by:
$${SNR}_{i} = \frac{{σ}_{X}^{2}}{{{σ}_{N}^{2} [ {( {H}_{1}^{{( L )}^{H}} ( t + L τ ) {H}_{1}^{( L )} ( t + L τ ) )}^{- 1} ]}_{ii}} = \frac{{σ}_{X}^{2} α ( L )}{{σ}_{N}^{2}}$$
$$where$$
$${α}_{i} ( L ) = {[ {( {H}_{1}^{{( L )}^{H}} ( t + L τ ) {H}_{1}^{( L )} ( t + L τ ) )}^{- 1} ]}_{ii}^{- 1} , \\ \begin{matrix}{α}_{1} ( L ) = {P}_{{H}_{2}^{( L )} ( t + l , τ )}^{\underline{1}} {H}_{1}^{( P )} ( t + L τ ) \\ = {‖ {H}_{i} ( t ) ‖}^{2} + {‖ {H}_{1}^{( L )} ( t + L τ ) ‖}^{2} - \\ \frac{{\vert {H}_{1}^{H} ( t ) {H}_{2} ( t ) + {\sum }_{k = 1}^{L} {h}_{[ {X}_{1} ]}^{H} ( t + k τ ) {h}_{[ {X}_{2} ]} ( t + k τ ) \vert}^{2}}{{‖ {H}_{2} ( t ) ‖}^{2} + {‖ {H}_{2}^{( L )} ( t + L τ ) ‖}^{2}}\end{matrix}$$
where P_{A}^{⊥}=I−P_{A} and P_{A} is an orthogonal projection onto a column space of A, and
when a margin is considered,
$${α}_{1} ( t + L τ ) = {‖ {H}_{1} ( t ) ‖}^{2} + ( 1 + {\sum }_{{}^{′} k = 1}^{L} {Δ}_{k} ) {‖ {h}_{i} ( t ) ‖}^{2} - \frac{\begin{matrix}{( 1 - \frac{1}{2} {Δ}_{L} )}^{2} ( {\vert {h}_{11} ( t ) \vert}^{2} {\vert {h}_{21} ( t ) \vert}^{2} {\vert {h}_{21} ( t ) \vert}^{2} {\vert {h}_{22} ( t ) \vert}^{2} ) + \\ 2 Re ( {h}_{11}^{*} ( t ) {h}_{21} ( t ) {h}_{12}^{*} ( t ) {h}_{22} ( t ) )\end{matrix}}{( 1 + {Δ}_{L} ) {‖ {h}_{j} ( t ) ‖}^{2}}$$
$$and$$
$${α}_{j} ( t + L τ ) = ( 1 + {\sum }_{{}^{′} k = 1}^{L} {Δ}_{k} ) {‖ {h}_{j} ( t ) ‖}^{2} - \frac{\begin{matrix}{( 1 - \frac{1}{2} {Δ}_{L} )}^{2} ( {\vert {h}_{11} ( t ) \vert}^{2} {\vert {h}_{21} ( t ) \vert}^{2} {\vert {h}_{21} ( t ) \vert}^{2} {\vert {h}_{22} ( t ) \vert}^{2} ) + \\ 2 Re ( {h}_{11}^{*} ( t ) {h}_{21} ( t ) {h}_{12}^{*} ( t ) {h}_{22} ( t ) )\end{matrix}}{{‖ {H}_{1} ( t ) ‖}^{2} + ( 1 + {Δ}_{L} ) {‖ {h}_{i} ( t ) ‖}^{2}} ,$$
where t+Lτ takes into account the margin by Lτ to the time t.

22. A receiver for an Automatic Repeat reQuest (ARQ) in a Multiple Input Multiple Output (MIMO) system, comprising:
a communication module having a plurality of antennas for communicating with multiple nodes; and
a controller for
receiving packets included first and second streams from a sender through the communication module,
computing a first smallest number of additional retransmissions to acquire a Signal to Noise Ratio (SNR) within or above an Adaptive Modulation and Coding (AMC) level for correcting an error of at least one packet when two of the packets are erroneous,
computing a second smallest number of retransmissions to acquire an SNR within or above the AMC level in an Antenna Selection (AS) mode for the first and second streams when the first smallest number of the transmissions is greater than a threshold, and
computing a throughput in the AS mode, after acquiring the second smallest number of the retransmissions.

23. The receiver of claim 22, wherein the controller computes a second throughput for the first smallest number of the retransmissions with respect to the first stream in a Space Multiplexing (SM) mode, when the first smallest number of the retransmissions is smaller than the threshold,
sets the second throughput as a throughput of the SM mode when an SNR of the second stream is within or above the AMC level, after the second throughput is acquired,
computes a third throughput for the second stream, when the SNR of the other stream is not within or above the AMC level after the second throughput is acquired,
sets a sum of the third throughput and the second throughput as a throughput of the SM mode,
compares the throughput of the SM mode with the throughput of the AS mode,
requests the retransmission of the AS mode, when the throughput of the AS mode is greater, and
requests the retransmission of the SM mode, when the throughput of the AS mode is smaller.

24. The receiver of claim 23, wherein the MIMO system adjusts a modulation level for a stream of each antenna, and selects an antenna.

25. The receiver of claim 22, wherein the controller computes throughputs for the first and second streams, respectively, and computes a throughput of the AS mode by adding products of the throughputs and the second number of the retransmissions.

26. The receiver of claim 22, wherein the SNR within or above the AMC level in the SM mode is expressed by:
$${SNR}_{i} = \frac{{σ}_{X}^{2}}{{{σ}_{N}^{2} [ {( {H}_{1}^{{( L )}^{H}} ( t + L τ ) {H}_{1}^{( L )} ( t + L τ ) )}^{- 1} ]}_{ii}} = \frac{{σ}_{X}^{2} α ( L )}{{σ}_{N}^{2}}$$
$$where$$
$${α}_{i} ( L ) = {[ {( {H}_{1}^{{( L )}^{H}} ( t + L τ ) {H}_{1}^{( L )} ( t + L τ ) )}^{- 1} ]}_{ii}^{- 1} , \\ \begin{matrix}{α}_{1} ( L ) = {P}_{{H}_{2}^{( L )} ( t + l , τ )}^{\underline{1}} {H}_{1}^{( P )} ( t + L τ ) \\ = {‖ {H}_{i} ( t ) ‖}^{2} + {‖ {H}_{1}^{( L )} ( t + L τ ) ‖}^{2} - \\ \frac{{\vert {H}_{1}^{H} ( t ) {H}_{2} ( t ) + {\sum }_{k = 1}^{L} {h}_{[ {X}_{1} ]}^{H} ( t + k τ ) {h}_{[ {X}_{2} ]} ( t + k τ ) \vert}^{2}}{{‖ {H}_{2} ( t ) ‖}^{2} + {‖ {H}_{2}^{( L )} ( t + L τ ) ‖}^{2}}\end{matrix}$$
where P_{A}^{⊥}=I−P_{A} and P_{A} is an orthogonal projection onto a column space of A, and
when a margin is considered,
$${α}_{1} ( t + L τ ) = {‖ {H}_{1} ( t ) ‖}^{2} + ( 1 + {\sum }_{{}^{′} k = 1}^{L} {Δ}_{k} ) {‖ {h}_{i} ( t ) ‖}^{2} - \frac{\begin{matrix}{( 1 - \frac{1}{2} {Δ}_{L} )}^{2} ( {\vert {h}_{11} ( t ) \vert}^{2} {\vert {h}_{21} ( t ) \vert}^{2} {\vert {h}_{21} ( t ) \vert}^{2} {\vert {h}_{22} ( t ) \vert}^{2} ) + \\ 2 Re ( {h}_{11}^{*} ( t ) {h}_{21} ( t ) {h}_{12}^{*} ( t ) {h}_{22} ( t ) )\end{matrix}}{( 1 + {Δ}_{L} ) {‖ {h}_{j} ( t ) ‖}^{2}}$$
$$and$$
$${α}_{j} ( t + L τ ) = ( 1 + {\sum }_{{}^{′} k = 1}^{L} {Δ}_{k} ) {‖ {h}_{j} ( t ) ‖}^{2} - \frac{\begin{matrix}{( 1 - \frac{1}{2} {Δ}_{L} )}^{2} ( {\vert {h}_{11} ( t ) \vert}^{2} {\vert {h}_{21} ( t ) \vert}^{2} {\vert {h}_{21} ( t ) \vert}^{2} {\vert {h}_{22} ( t ) \vert}^{2} ) + \\ 2 Re ( {h}_{11}^{*} ( t ) {h}_{21} ( t ) {h}_{12}^{*} ( t ) {h}_{22} ( t ) )\end{matrix}}{{‖ {H}_{1} ( t ) ‖}^{2} + ( 1 + {Δ}_{L} ) {‖ {h}_{i} ( t ) ‖}^{2}} , .$$
where t+Lτ takes into account the margin by Lτ to the time t.
